(19) United States
(12) Patent Application Publication
(10) Pub. No.: US 2022/0131235 A1
(43) Pub. Date: Apr. 28, 2022

(54) BATTERY

(71) Applicant: Robert Bosch GmbH, Stuttgart (DE)

(72) Inventors: Peter Kunert, Lichtenstein (DE); Dennis Mehlo, Taipei (TW); Lisa Bayer, Stuttgart (DE)

(21) Appl. No.: 17/452,184

(22) Filed: Oct. 25, 2021

(30) Foreign Application Priority Data
Oct. 27, 2020 (DE) 10 2020 213 480.4

(51) Int. Cl. H01M 50/503; H01M 50/507

(52) U.S. Cl. CPC H01M 50/503; H01M 2220/20; H01M 50/507

(57) ABSTRACT

A battery including first and second cell stacks, electrically conductive cell connectors, and an electrically conductive stack connector. The battery cells of the cell stacks are positioned in parallel with each other. The cell connectors are situated on contacting sides of the cell stacks and each electrically interconnect at least two battery cells per contacting side and provide this electrical connection in a first and/or second contacting section of the battery using respective contact tabs. The stack connector is formed in one layer and is configured to bring together voltages of electrically connected battery cells provided by the contact tabs in the first contacting section, at a power terminal of the battery, to form an overall voltage of the battery. At least two adjacent contact tabs of the first cell stack and of the second cell stack are interconnected electrically in the second contacting section.

### CROSS REFERENCE

The present application claims the benefit under 35 U.S.C. § 119 of German Patent Application No. DE 102020213480.4 filed on Oct. 27, 2020, which is expressly incorporated herein by reference in its entirety.

### FIELD

The present invention relates to a battery, in particular, a battery for an electrically powered locomotion device.

### BACKGROUND INFORMATION

Electrically powered, two-wheeled vehicles and, in particular, electric bicycles, also referred to as e-bikes, which use batteries as a power source for the electric drive unit, are available in the related art; the batteries being made up of a plurality of battery stacks containing a plurality of battery cells. It is conventional that the individual battery cells may be positioned inside of the battery stacks in such a manner, that they may be inserted into a tubular housing, using a space-saving configuration; the housing being able to be attached, for example, to a frame of such two-wheeled vehicles. Such a type of design for batteries of electrically powered two-wheeled vehicles is also known by the designation “powertube” construction. Specific series and parallel connections of battery cells of the battery are made mostly directly via electrically conductive cell connectors, which are positioned at specific contacting regions (poles) of the battery cells. A battery management system (BMS) and an attachment plug of such batteries are normally situated at the end faces of the battery (also referred to as a “core pack”). Thus, both a serial power circuit, which is produced via lines and/or overlapping contact tabs of the cell connectors, and a monitoring circuit for the individual cell potentials, which is implemented via wires or flexible circuit boards, are guided to the end face.

Appropriate, special insulating measures must be taken for resulting crossing points of specific lines, in order to prevent an internal short circuit of the battery. In particular, in the case of high battery capacities, correspondingly many crossing points may be formed.

### SUMMARY

The present invention provides a battery, which is, in particular, a power source for an electrically powered locomotion device, preferably, for an electrically powered two-wheeled vehicle and, particularly preferably, for an electrically powered bicycle. In addition, it is possible to use the battery of the present invention in types of locomotion devices different from these, such as in e-rollers or also four-wheeled electric vehicles. The battery of an example embodiment of the present invention includes a first cell stack having a first configuration of battery cells, a second cell stack having a second configuration of battery cells, a plurality of electrically conductive cell connectors, and at least one electrically conductive stack connector. The battery cells are preferably formed in the shape of round cells, whose respective electric poles are situated on sides of the battery cells opposite to each other. It should be pointed out that battery cell designs different from this may also be used in connection with the battery of the present invention, and that the above-mentioned, preferred type of construction is not to be viewed as a limitation to this design. The battery cells inside of the respective cell stacks are positioned parallelly to each other with regard to their specific direction of longitudinal extension, which means that specific, opposite electrical contacting regions (poles) of the battery cells are provided at a first contacting side and at a second contacting side of the respective cell stacks. In addition, the first cell stack and the second cell stack are interconnected immovably in such a manner, that one of the contacting sides of the first cell stack faces one of the contacting sides of the second cell stack; specific contacting regions of the battery cells of the respective cell stack facing each other being spaced apart from each other. In other words, the contacting regions of battery cells facing each other are not in direct contact. The electrical contact between specific battery cells inside of a cell stack is produced by the above-mentioned cell connectors, which are situated on the specific contacting sides of the cell stack, and which each interconnect at least two battery cells per contacting side electrically (in parallel and/or in series) and provide this electrical connection, using specific contact tabs in a first contacting section of the battery and/or in a second contacting section of the battery different from the first contacting section. The two contacting sections are to be understood, in particular, as sections of an outer surface of the battery, which overlap cell stacks, and in which the contact tabs of the respective cell connectors are positioned so as to be accessible from the outside. In addition, the at least one stack connector is formed in one layer (that is, it does not have any crossing circuit traces) and is configured to bring together voltages of electrically connected battery cells provided by the contact tabs in the first contacting section, at a power terminal of the battery, to form an overall voltage of the battery. A position, at which the overall voltage is provided by the at least one stack connector, is preferably a position on one of the end faces of the battery, without being limited to such a position by this. For such a combination of the individual voltages to form an overall voltage, it is also possible for more than one electrically conductive stack connector to be used; such a plurality of stack connectors being positioned one behind the other and interconnected electrically in the direction of longitudinal extension of the battery. In this context, a number of electrically connected stack connectors is not limited to a particular number, and in addition, it is possible for the individual stack connectors to be formed differently. To obtain the considerable advantages of the battery of the present invention, which are manifested, in particular, in simplified manufacture and associated cost savings, it is advantageous to stipulate a number of stack connectors in view of a number of manufacturing steps that is as small as possible, and/or in view of a component sharing principle (that is, use of a number of different cell connectors that is as small as possible). In addition, in order to supply the overall voltage in the first contacting section, the battery of the present invention provides for at least two adjacent contact tabs of the first cell stack and of the second cell stack to be electrically interconnected in the second contacting section. This means that by suitably interconnecting specific battery cells, using respective cell connectors, and by electrically contacting the respective cell stacks at least partially with the aid of the contact tabs of the cell connectors inside of the second contacting section, in contrast to the related art, no individual wiring (and, in particular, no intersecting wiring) of cell potentials of the battery has to be used, in order to generate the desired overall voltage of the battery. Instead, the concept of the present invention provides a simple and, with regard to the manufacture, rapid and cost-effective contacting option, by connecting specific contact tabs in the first contacting section of the battery with the aid of the at least one stack connector. In general, it should be pointed out that the number of cell stacks, two, of the battery of the present invention described here represents merely a minimum number, and that in conformance with the above description, the battery may include additional cell stacks.

Preferred further refinements of the present invention are disclosed herein.

A number of battery cells of the battery inside the first configuration of battery cells and a number of battery cells inside the second configuration of battery cells is preferably identical. Alternatively, or in addition, regarding the orientation of specific poles of the battery cells inside of the first configuration and inside of the second configuration, there is at least one difference between the first configuration and the second configuration. In other words, with regard to the orientation of its poles, at least one battery cell of the one cell stack is rotated 180° with respect to a battery cell of the other respective cell stack; the battery cell of the other respective cell stack being situated inside of the second cell stack at the same position as the battery cell inside of the first cell stack.

It is particularly advantageous for the battery of the present invention to have six electrically interconnected cell stacks; each cell stack having ten battery cells, which are preferably positioned, in each instance, one on top of the other in three planes, in a 3-4-3 configuration (which is particularly compact); in each instance, six battery cells within one cell stack or in overlapping cell stacks being interconnected in parallel; and respective battery cells interconnected in parallel being connected in series for generating the overall voltage of the battery. For this reason, such an interconnection configuration of battery cells of the battery is also referred to as a “10s6p” configuration, since in each instance, six battery cells are interconnected in parallel and ten such parallel circuit arrangements are connected in series.

In one advantageous embodiment of the present invention, the battery includes three, four, five or more cell stacks, which preferably have ten battery cells each.

The stack connector is preferably a lead frame, in particular, a lead frame connected to a plastic holder. The plastic holder allows, inter alia, a plurality of electrically isolated sections of the lead frame to be positioned in a stationary manner. A connection between the lead frame and the plastic holder may be ensured, for example, with the aid of an adhesive joint and/or with the aid of an insert manufacturing method, by which the plastic holder and the lead frame generate a form-locked connection. A suitable material for the lead frame is, for example, copper or an electrically conductive material different from it. As an alternative to the use of such a lead frame, it is also possible to use a circuit board provided with circuit traces. In addition, the stack connector is configured to electrically interconnect contact tabs inside of a cell stack and/or contact tabs of different cell stacks. In the case of use of a plurality of stack connectors within the first contacting section of the battery, it is also possible to interconnect the specific stack connectors directly and/or to interconnect them via the contact tabs. Alternatively, it is also possible to interconnect the specific stack connectors electrically with the aid of other connecting elements.

Furthermore, it is advantageous for at least a portion of the contact tabs of the cell connectors to be configured to be folded, in each instance, onto a contact tab of an adjacent cell stack in such a manner, that the two contact tabs overlap. For this, it is possible for the portion of the contact tabs, which are folded, in each instance, onto the adjacent contact tabs, to have a greater length than the respective, adjacent contact tabs. This does not explicitly preclude all of the contact tabs from having the same length. In addition, the contact tabs are configured to be connected electrically to, in each instance, adjacent contact tabs; this connection being, in particular, a welded and/or soldered connection. Moreover, it is also possible to electrically contact specific contact tabs with each other with the aid of a screw connection and/or clamped connection and/or type of connection different from them.

It is particularly advantageous for the battery to be configured to supply all of the present, partial voltages of respective, parallelly connected battery cells via the contact tabs of the cell connectors in the second contacting section. This provides the advantage that, for example, monitoring of all individual potentials is rendered possible by access via the contact flags in the second contacting section. Such monitoring is carried out, for example, in a battery management system (BMS) of the battery.

The above-described stack connector is preferably a first stack connector, while the battery additionally has a second stack connector, which is configured to bring together specific, individual potentials of the battery supplied in the second contacting section, at a signal terminal of the battery. For example, the signal terminal is situated, as is the power terminal, at one of the end faces, in particular, at the same end face, at which the power terminal is situated. Mounting positions of the signal terminal different from this are possible, as well.

The second stack connector is preferably a circuit board and, in particular, a flexible circuit board (FCB). This allows the specific, individual potentials of the battery to be brought together at the signal terminal of the battery in a particularly simple manner via respective circuit traces of the circuit board. It should be pointed out that the second stack connector is advantageously a single electrical connecting element, but that this may also be made up of a plurality of individual, second stack connectors in a manner analogous to the first stack connector.

In one advantageous refinement of the present invention, the first contacting section and the second contacting section of the battery are situated, in each instance, on opposite sides (e.g., on an upper side and a lower side) of the battery.

Since the battery of the present invention is intended, in particular, for use in electrically powered two-wheeled vehicles (without being limited to them), an overall voltage of 36 V and/or 48 V is preferably supplied by the battery of the present invention.

### BRIEF DESCRIPTION OF THE DRAWINGS

Below, exemplary embodiments of the present invention are described in detail with reference to the figures.

FIG. 1 shows a circuit diagram representing a configuration and wiring of battery cells of a first specific embodiment of a battery according to the present invention.

FIG. 2 shows a side view of an example of a cell stack of a battery according to the present invention.

FIG. 3 shows a schematic view of cell connectors for a second specific embodiment of a battery according to the present invention.

FIG. 4 shows a top view of a first contacting section of a third specific embodiment of a battery according to the present invention.

FIG. 5 shows a top view of a second contacting section of the third specific embodiment of a battery according to the present invention.

### DETAILED DESCRIPTION OF EXAMPLE EMBODIMENTS

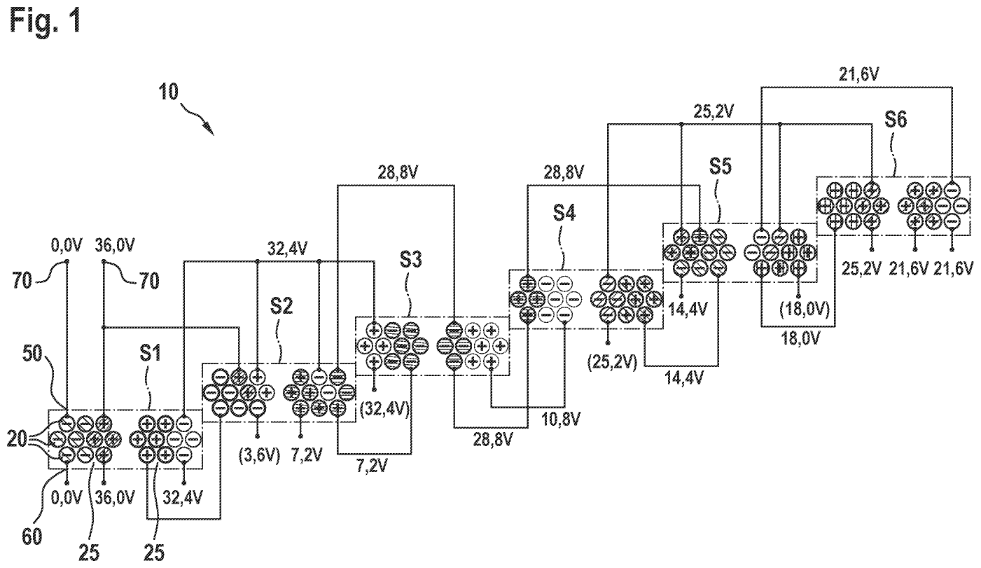

FIG. 1 shows a circuit diagram representing a configuration and wiring of battery cells 20 of a first specific embodiment of a battery 10 according to the present invention. The specific embodiment shown here represents a 10s6p configuration of the specific battery cells 20, which includes six cell stacks S1, S2, S3, S4, S5, S6. In each cell stack S1, S2, S3, S4, S5, S6, ten battery cells 20 are positioned, in each instance, in parallel with each other in the form of a 3-4-3 stack. In each instance, the battery poles shown in left and right regions of each cell stack S1, S2, S3, S4, S5, S6 correspond to diametrically opposed electrical contacting regions 25 of respective battery cells 20. Specific parallel and/or series, electrical connections of contacting regions (poles) 25 of battery cells 20 are produced with the aid of respective cell connectors 30 (not shown). Additionally apparent, are the different groupings and/or orientations of battery cells 20 inside of respective cell stacks S1, S2, S3, S4, S5, S6 in accordance with the present invention. For example, the group of four parallelly interconnected positive poles in cell stack S1 is connected electrically to a group of two parallelly interconnected positive poles in cell stack S2, in order to produce a parallel connection of a total of six battery cells 20. The side of each cell stack S1, S2, S3, S4, S5, S6 portrayed as the upper side of battery 10 represents the side, on which first contacting section 50 is situated; specific contact tabs 35 of respective cell connectors 30 being positioned in the first contacting section so as to be accessible from the outside (that is, outside of respective cell stacks S1, S2, S3, S4, S5, S6). The overall voltage of battery 10 is supplied at a power terminal 70, by contacting the individual cell stacks S1, S2, S3, S4, S5, S6 one below the other with the aid of a first stack connector, which, in this case, is made of a copper lead frame. The side of cell stacks S1, S2, S3, S4, S5, S6 portrayed as the lower side represents the side, on which second contacting section 60 is situated; the specific, individual potentials of battery 10 (indicated by respective voltage values) being provided in the second contacting section by contact tabs 35 of respective cell connectors 30. Specific individual potentials of battery 10 are brought together at a signal terminal of battery 10 with the aid of a second stack connector, which, in this case, takes the form of a flexible circuit board. Thus, the shown distribution and interconnection of battery cells 20 allows the advantage of the present invention of simplified contacting of specific battery cells 20 and/or cell stacks S1, S2, S3, S4, S5, S6 by the first stack connector and the second stack connector, to be achieved.

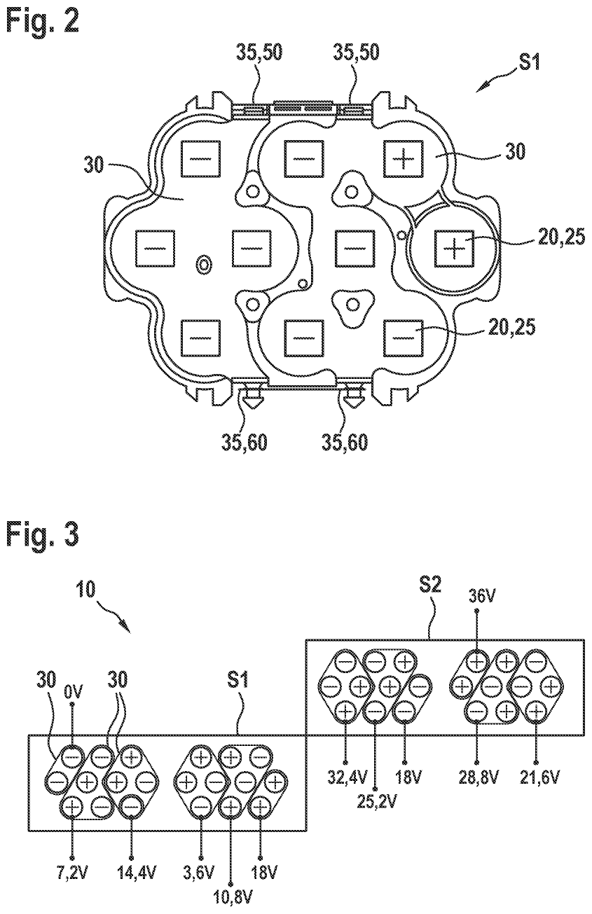

FIG. 2 shows an illustrative side view of a cell stack S1 of a battery 10 according to the present invention. The side view represents one of the contacting sides of cell stack S1, which includes ten battery cells 20. Specific cell connectors 30 are shown, which interconnect respective contacting regions 25 of battery cells 20 in series and/or in parallel. Specific contact tabs 35 provided by cell connectors 30 are supplied in first contacting section 50 and in second contacting section 60 of battery 10 so as to be accessible from the outside, which means that specific individual potentials of battery 10 may be accessed on an outer side of cell stack S1.

FIG. 3 shows a schematic view of cell connectors 20 for a second specific embodiment of a battery 10 according to the present invention. In this specific embodiment, battery 10 includes two cell stacks S1, S2, which each have ten battery cells 20. Electrical contacting of specific battery cells 20 inside of the two cell stacks S1, S2 is made by above-described cell connector 30, which is indicated here schematically with the aid of a border of, in each instance, battery cells 20 to be connected.

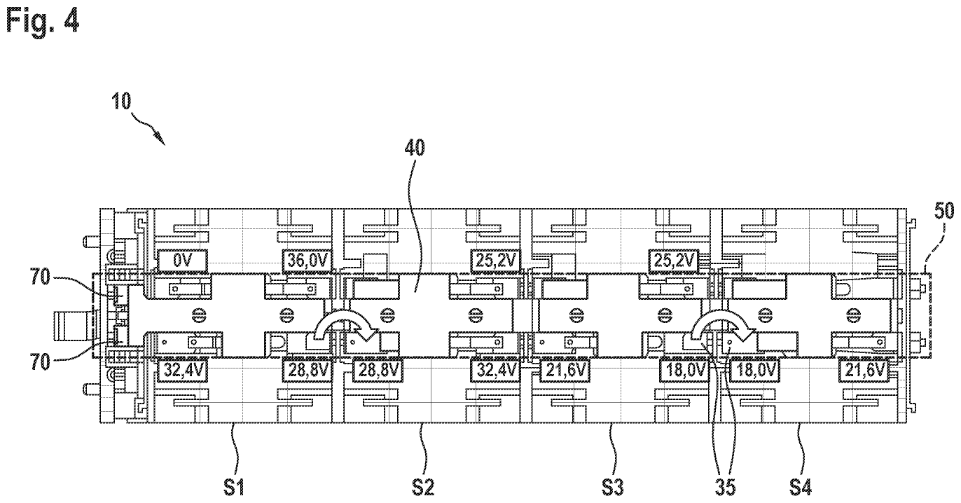

FIG. 4 shows a top view of a first contacting section 50 of a third specific embodiment of a battery 10 according to the present invention. A first stack connector 40, which interconnects the individual (unshown) cell connectors 30 of cell stacks S1, S2, S3, S4 of battery 10 electrically in such a manner, that an overall voltage of battery 10 is supplied at a power terminal 70, is shown in first contacting section 50. First stack connector 40 is formed in the shape of a copper lead frame, which is integrated in a plastic holder. First stack connector 40 is connected electrically to a portion of the contact tabs 35 of respective cell stacks S1, S2, S3, S4 with the aid of welded connections. Additional, necessary electrical connections between cell stacks S1 and S2 and/or between cell stacks S3 and S4 are produced by direct contacting of contact tabs 35, in that specific contact tabs 35 of adjacent cell stacks S1, S2, S3, S4 provided for this are folded onto each other in the direction of the arrow and subsequently welded to each other. In addition, the voltages of battery 10 available in this configuration of battery cells 20 in first contacting section 50 are shown.

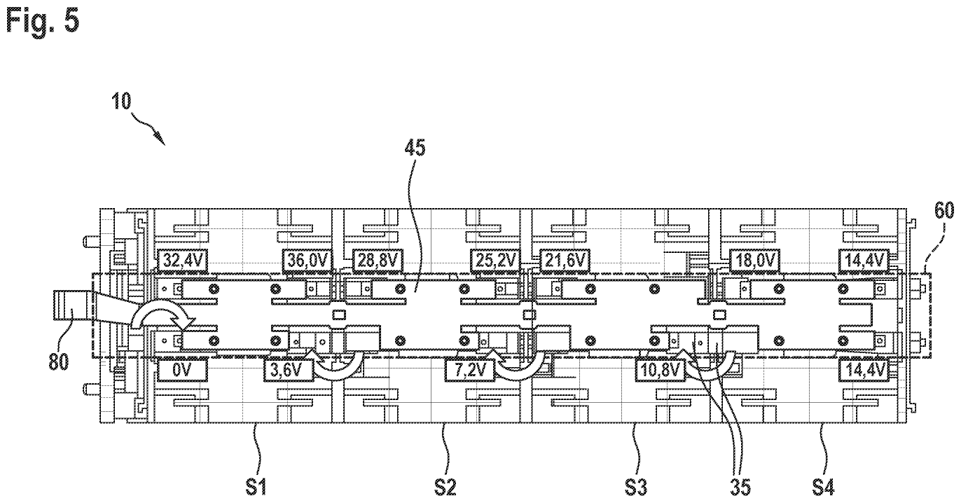

FIG. 5 shows a top view of a second contacting section 60 of the third specific embodiment of a battery 10 according to the present invention. In this case, second contacting section 60 is on the side of battery 60 opposite to that described in FIG. 4. The specific contact tabs 35 of cell connectors 30, which are provided in second contacting section 60 of battery 10, are shown. With the aid of a second stack connector 45, which, in this case, takes the form of a flexible circuit board, all of the supplied, individual potentials of battery 10 are brought together at a signal terminal 80 of the battery, so that monitoring of the individual potentials of battery 10 is enabled. In the second contacting section 60 of battery 10, as well, some of the contact tabs 35 are contacted directly (in each instance, in the direction of the arrow) by folding and welding.

What is claimed is:

1. A battery, comprising:
a first cell stack having a first configuration of respective battery cells;
a second cell stack having a second configuration of respective battery cells;
a plurality of electrically conductive cell connectors; and
at least one electrically conductive stack connector;
wherein:
the respective battery cells inside each of the first cell stack and the second cell stack are positioned parallelly to each other with regard to their specific direction of longitudinal extension, so that specific electrical contacting regions of the respective battery cells lying opposite to each other are provided on a first contacting side and on a second contacting side of the respective first cell stack and the second cell stack;
the first cell stack and the second cell stack are interconnected immovably in such a manner, that one of the first and second contacting sides of the first cell stack faces one of the first and second contacting sides of the second cell stack, the specific contacting regions of the respective battery cells of the first and second cell stacks facing each other are spaced apart from each other;
the cell connectors are situated on the first and second contacting sides of the first and second cell stacks, and each interconnect at least two battery cells electrically per contacting side and provide an electrical connection using respective contact tabs in a first contacting section of the battery and/or in a second contacting section of the battery different from the first contacting section;
the at least one stack connector is formed in one layer and is configured to combine voltages of electrically connected battery cells supplied by the respective contact tabs in the first contacting section, at a power terminal of the battery, to form an overall voltage of the battery; and
at least two adjacent respective contact tabs of the first cell stack and of the second cell stack are electrically interconnected in the second contacting section to supply the overall voltage in the first contacting section.

2. The battery as recited in claim 1, wherein:
a number of the respective battery cells inside the first configuration of respective battery cells and a number of the respective battery cells inside the second configuration of respective battery cells are identical; and/or
orientations of specific poles of the respective battery cells inside of the first configuration and inside of the second configuration have at least one difference between the first configuration and the second configuration.

3. The battery as recited in claim 1, wherein:
the battery includes six cell stacks connected electrically to each other;
each of the six cell stacks has ten battery cells, which are positioned, in each instance, one on top of the other in three planes in a 3-4-3 configuration;
the battery cells within each of the six cell stacks or in overlapping cell stacks are interconnected in parallel; and
respective battery cells interconnected in parallel are connected in series for generating the overall voltage of the battery.

4. The battery as recited in claim 1, wherein the battery includes at least three cell stacks which have ten battery cells each.

5. The battery as recited in claim 1, wherein each of the at least one stack connector is a lead frame connected to a plastic holder or a single-layer circuit board, and is configured to interconnect the respective contact tabs electrically within a cell stack and/or the respective contact tabs of different cell stacks.

6. The battery as recited in claim 1, wherein at least a portion of the respective contact tabs of the cell connectors are configured to be folded onto a contact flag of, in each instance, an adjacent cell stack in such a manner, that two contact flags overlap, and are configured to be connected electrically to an adjacent contact flag by a welded and/or soldered connection.

7. The battery as recited in claim 1, wherein the battery is configured to supply all available, partial voltages of respective, parallelly connected battery cells via the respective contact tabs of the cell connectors in the second contacting section.

8. The battery as recited in claim 1, wherein:
the at least one stack connector is a first stack connector; and
the battery includes a second stack connector which is configured to bring together specific, individual potentials of the battery supplied in the second contacting section, at a signal terminal of the battery.

9. The battery as recited in claim 8, wherein the second stack connector is a flexible circuit board.

10. The battery as recited in claim 1, wherein the first contacting section and the second contacting section are situated on opposite sides of the battery relative to one another.

11. The battery as recited in claim 1, wherein the battery is configured to supply an overall voltage of 36 V or 48 V.
